(19) United States
(12) Patent Application Publication
(10) Pub. No.: US 2002/0152367 A1
(43) Pub. Date: Oct. 17, 2002

(54) SIMD digital signal processor and arithmetic method for the same

(75) Inventor: Jong Bum Park, Kyounggi-Do (KR)

Correspondence Address: JONATHAN Y. KANG, ESQ., LEE & HONG P.C., 11th Floor, 221 N. Figueroa Street, Los Angeles, CA, 90012-2601, US

(73) Assignee: LG Electronics Inc.

(21) Appl. No.: 10/092,643

(22) Filed: Mar. 5, 2002

(30) Foreign Application Priority Data
Apr. 13, 2001 (KR) 19900/2001

(51) Int. Cl. G06F 9/30

(52) U.S. Cl. 712/22; 712/208

(57) ABSTRACT

A Single Instruction Multiple Data (SIMD) digital signal processor includes an on-chip program memory for storing an instruction data of a program, a plurality of main instruction decoders for outputting a decoding signal by decoding the instruction data, an on-chip data memory for storing data and a plurality of arithmetic units for calculating the data according to the decoding signal and an arithmetic method for the same includes the steps of decoding an instruction data patched from an on-chip program memory in the main instruction decoder and calculating according to the characteristic of the instruction data after determining the characteristic of the decoded instruction data, thus to reduce calculation time in case of a digital signal processing algorithm having a small size of a data block to be processed and many conditional branches.

### BACKGROUND OF THE INVENTION

1. Field of the Invention

The present invention relates to a Single Instruction Multiple Data (SIMD) digital signal processor and an arithmetic method for the same and particularly, to a digital signal processor for a single instruction multiple data and an arithmetic method for the same which is improved to reduce calculation amount of an algorithm having many conditional branches.

2. Description of the Background Art

Generally, a digital signal processor processes a plurality of data in the 1-cycle by applying architecture such as a Single Instruction Multiple Data (SIMD), Very Long Instruction Word (VLIW), Superscalar and the like.

FIG. 1 is a block diagram showing a digital signal processor in accordance with the conventional art. As shown in the drawing, the digital signal processor includes registers 101 and 102 for storing 16-bit input data, an arithmetic unit 103 for calculating the data stored in the register according to the corresponding instruction after fetching the register and a register 104 for receiving the data calculated in the arithmetic unit 103 and storing the data.

FIG. 2 is a block diagram showing a SIMD digital signal processor in accordance with the conventional art. As shown in the drawing, the SIMD digital signal processor includes registers 201 and 202 for storing 32-bit input data, an arithmetic units 203 and 204 for calculating the data stored in the registers 201 and 202 according to the corresponding instruction after fetching the above registers and a register 205 for receiving the data calculated in the arithmetic units 203 and 204 and storing the data.

The digital signal processor with the above composition will be described as follows.

The arithmetic unit 103 calculates the data stored in the registers 101 and 102 by fetching the data when the 16-bit data is stored in the registers 101 and 102 and then stores the calculated data in the register 104. In case of a SIMD instruction data, when the each 16-bit input data is stored, each stored data is calculated in the two arithmetic units 203 and 204 simultaneously and the calculated data is stored in the register 205.

Namely, the digital signal processor shown in FIG. 1 includes just an arithmetic unit 103. However, since the SIMD digital signal processor shown in FIG. 2 includes two arithmetic units 203 and 204 for processing data, the digital signal processor of FIG. 2 reduces the calculation time to the half of the time of the digital signal processor of FIG. 1. For instance, in case of the Finite Impulse Response (FIR) filter calculation, since if the data to be processed is 256-bit and the number of the taps is 10, calculation must be repeated 256*10 times, 2560-cycle is needed. However, just 1280-cycles are necessary in case of using the SIMD digital signal processor shown in FIG. 2.

However, in case of a digital signal processing algorithm having a small size of the data block to be processed and many conditional branches, there occurs disadvantages that even if the SIMD digital signal processor shown in FIG. 2 is used, calculation amount capable of being simultaneously calculated in the whole calculation is not large and it is difficult to reduce calculation time since calculation amount is not different much from that of the signal processor in accordance with the conventional art.

### SUMMARY OF THE INVENTION

Therefore, the present invention provides a Single Instruction Multiple Data (SIMD) digital signal processor and an arithmetic method for the same, capable of reducing time for calculating a digital signal processing algorithm having a small size of the data block to be processed and many conditional branches.

To achieve these and other advantages and in accordance with the purpose of the present invention, as embodied and broadly described herein, there is provided an improved SIMD signal processor, including an on-chip program memory for storing an instruction data of a program, a plurality of main instruction decoders for outputting a decoding signal by decoding the instruction data, an on-chip data memory for storing data and a plurality of arithmetic units for calculating the data according to the decoding signal.

Also, to achieve these and other advantages and in accordance with the purpose of the present invention, as embodied and broadly described herein, there is provided an arithmetic method for the improved SIMD signal processor, including the steps of decoding an instruction data fetched from an on-chip program memory in the main instruction decoder and calculating according to the characteristic of the instruction data after determining the characteristic of the decoded instruction data.

The foregoing and other, features, aspects and advantages of the present invention will become more apparent from the following detailed description when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram showing a digital signal processor in accordance with the conventional art;

FIG. 2 is a block diagram showing a SIMD digital signal processor in accordance with the conventional art;

FIG. 3 is a block diagram showing an improved SIMD digital signal processor in accordance with the present invention.

FIG. 4 is a data flow chart showing the data flow in case a normal instruction is calculated in FIG. 3;

FIG. 5 is a data flow chart showing the data flow in case a SIMD instruction is calculated in FIG. 3;

FIG. 6 is a data flow chart showing the data flow in case an instruction of a conditional branch is calculated in FIG. 3; and

FIG. 7 is a data flow chart showing the data flow after the condition is determined in FIG. 3.

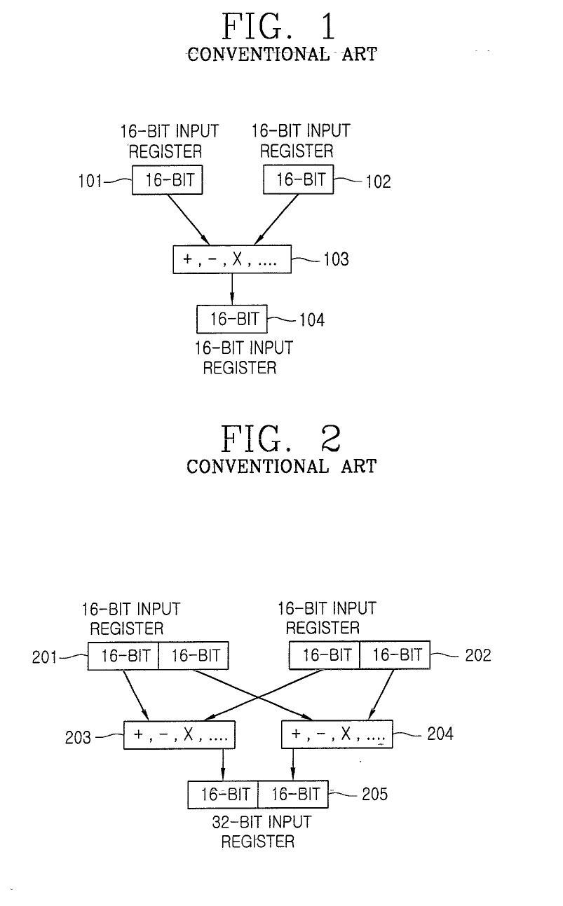

### DETAILED DESCRIPTION OF THE PREFERRED EMBODIMENTS

Reference will now be made in detail to the preferred embodiments of the present invention, examples of which are illustrated in the accompanying drawings.

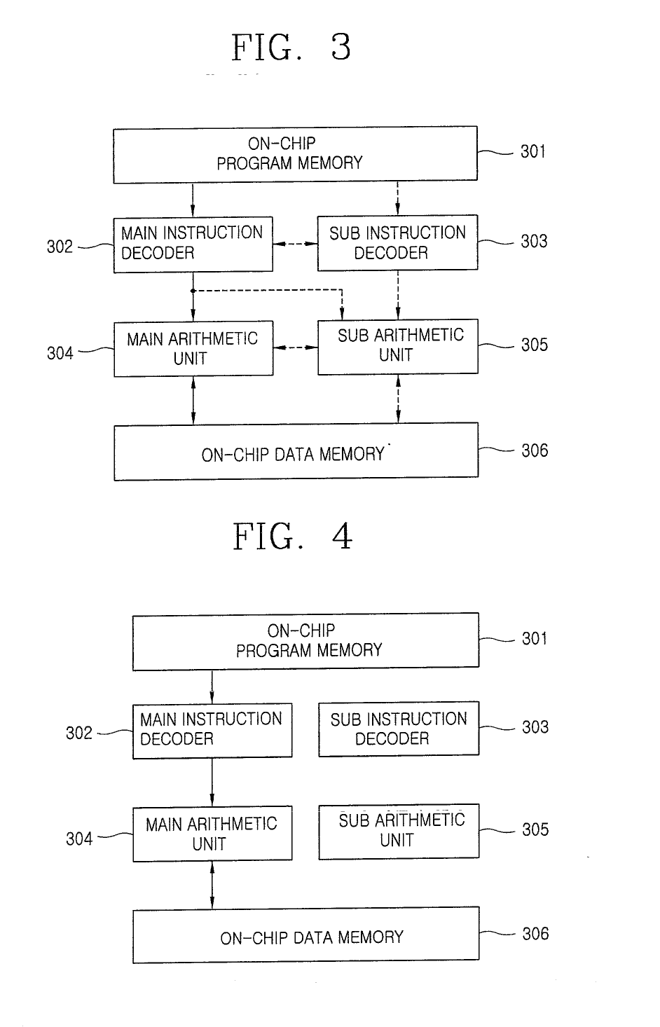

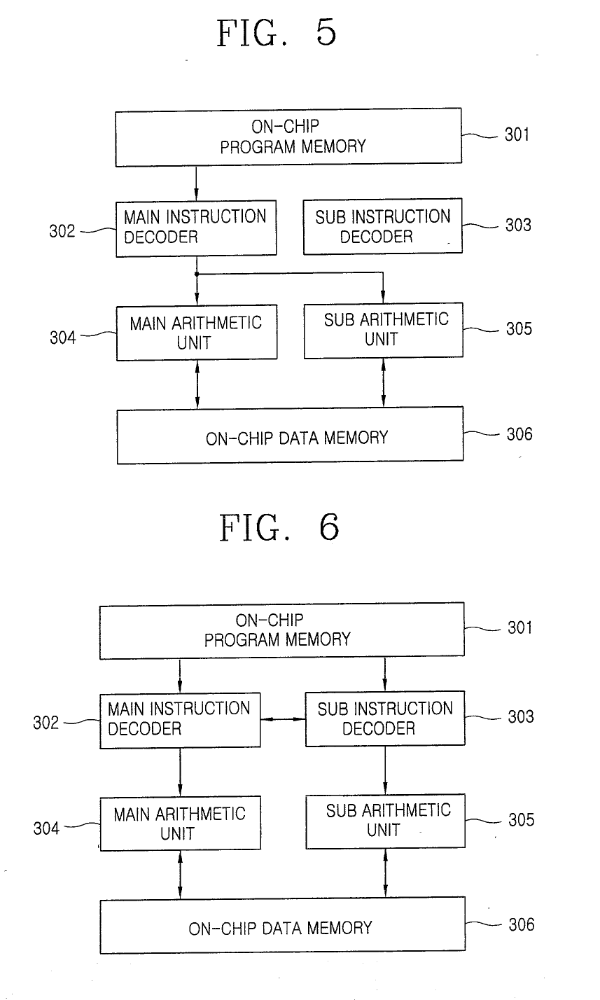

FIG. 3 is a block diagram showing an improved SIMD digital signal processor in accordance with the present invention. As shown in the drawing, the improved SIMD digital signal processor includes an on-chip program memory 301 for storing an instruction data for digital signal processing, a main instruction decoder 302 for decoding the instruction data by fetching the instruction data stored in the on-chip program memory 301 and outputting corresponding decoding signal, a sub instruction decoder 303 for decoding a received instruction data by fetching the instruction data stored in the on-chip program memory 301 in case of an instruction mode related to a conditional branch and outputting the corresponding decoding signal, an on-chip data memory 306 for storing the plurality of data for digital signal processing, a main arithmetic unit 304 for calculating the data according to the decoding signal of the main instruction decoder 302 and a sub arithmetic unit 305 for calculating the data identically as the main arithmetic unit 304 according to the decoding signal of the main instruction decoder 302 or calculating the data according to the decoding signal of the sub instruction decoder 303. Here, an arrow displayed with a solid line shows data flow in the normal mode and an arrow displayed with a dotted line shows data flow in the particular mode.

The digital signal processor in accordance with the present invention with above composition will be described as follows.

Firstly, the main instruction decoder 302 decodes the instruction data fetched from the on-chip program memory 301. Then, the signal processor in accordance with the present invention operates differently when the decoded instruction data corresponds to the instruction of a conditional branch or SIMD instruction or normal instruction, respectively.

First, in case of calculating a normal instruction, the decoder operates as in FIG. 4. Namely, the decoded instruction data is transmitted to the main arithmetic unit 304. Then, the main arithmetic unit 304 calculates the data according to the instruction data by reading the data needed for calculation from the on-chip data memory 306 and stores the calculated data in the register (not shown) contained in the main arithmetic unit 304. At this time, the sub instruction decoder 303 and the sub arithmetic unit do not operate.

Also, in case of calculating a conditional branch, the decoder operates as in FIG. 6. Namely, the decoded instruction data is transmitted to the main arithmetic unit 304. The main arithmetic unit 304 calculates data needed for calculation according to the instruction data by reading the data from the on-chip data memory 306 and stores the data in the register contained in the main arithmetic unit 304. Here, the main arithmetic unit 304 calculates the condition contained in the conditional branch. Then, the data is decoded and calculated by simultaneously fetching the instruction data to be performed in case the condition of the conditional branch is satisfied and not satisfied. Namely, the main instruction decoder 302 and the sub instruction decoder 303 respectively decode the data by simultaneously fetching the instruction data to be performed in case the condition of the conditional branch is satisfied and not satisfied and transmit the decoded instruction data in to the main arithmetic unit 304 and sub arithmetic unit 305 independently. Then, the main arithmetic unit 304 and sub arithmetic unit 305 calculate the data needed for calculation according to the decoded instruction data by respectively reading the data from the on-chip data memory 306 and store the data in the register (not shown) contained in respective arithmetic units 304 and 305. Namely, the main arithmetic unit 304 and sub arithmetic unit 305 calculate according to the respective decoded instruction data independently.

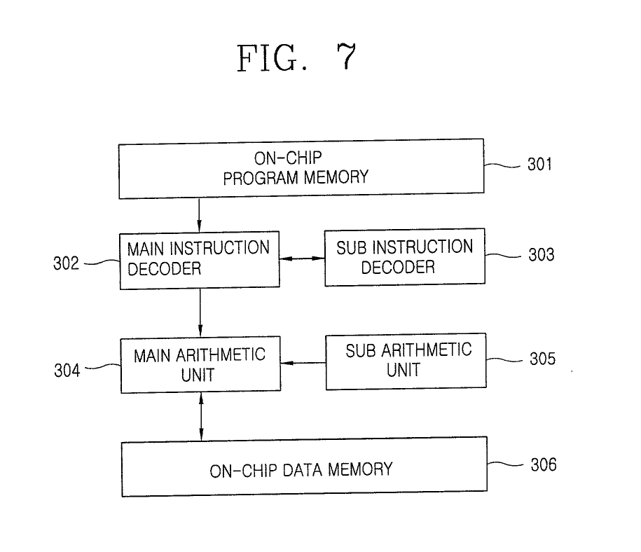

Later, when the condition is determined, operation of the present invention is performed as in FIG. 7. Namely, in case the result from the condition of the conditional branch satisfies the condition, condition of the main instruction decoder 302 and main arithmetic unit 304 is left as it is and the conditional information of the sub arithmetic unit 305 and sub instruction decode 306 is deleted. However, if the result does not satisfy the condition, the main instruction decoder 302 and the main arithmetic unit 304 delete the conventional conditional information and replace the information with the conditional information of the sub arithmetic unit 305 and sub instruction decoder 303. Then, the process after the conditional branch is continuously proceeded.

As described above, to reduce the calculation amount in processing an algorithm having many conditional branches, the present invention calculates related to a conditional branch when the conditional branch is occurred by having the main instruction decoder 302 and sub instruction decoder 303 and has the main arithmetic unit 304 and the sub arithmetic unit 305 perform independently different calculation until the condition is determined, thus to prevent instruction performance delay related with the conditional branch.

Also, the present invention can reduce the calculation time of an algorithm having many conditional branches since the present invention can prevent instruction performance delay related with the conditional branch and reduce the calculation amount.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A Single Instruction Multiple Data (SIMD) digital signal processor, comprising:
an on-chip program memory for storing an instruction data of a program;
a plurality of main instruction decoders for decoding the instruction data and outputting a decoded signal;
an on-chip data memory for storing data; and
a plurality of arithmetic units for calculating the data according to the decoding signal.

2. The processor of claim 1, wherein the plurality of instruction decoders comprise:
a main instruction decoder for decoding an instruction data performed in case the above condition is satisfied, according to the condition of the conditional branch; and
a sub instruction decoder for decoding an instruction data performed in case the above condition is not satisfied.

3. The processor of claim 1, wherein the plurality of arithmetic units independently or identically calculate according to the characteristic of the instruction data.

4. A Single Instruction Multiple Data (SIMD) digital signal processor, comprising:
an on-chip program memory for storing an instruction data of a program;
a main instruction decoder for decoding the instruction data and outputting a decoded signal;
a sub instruction decoder for decoding a received instruction data in case of an instruction mode related to a conditional branch;
an on-chip data memory for storing the data;
a main arithmetic unit for calculating the data according to the decoded signal of the main instruction decoder; and
a sub arithmetic unit for calculating the data identically as the main arithmetic unit according to the decoded signal of the main instruction decoder or calculating the data according to the decoded signal of the sub instruction decoder.

5. An arithmetic method for a Single Instruction Multiple Data (SIMD) digital signal processor, comprising the steps of:
decoding an instruction data fetched from an on-chip program memory in the main instruction decoder; and
calculating according to the characteristic of the instruction data after determining the characteristic of the decoded instruction data.

6. The method of claim 5, further comprising the steps of:
transmitting the decoded instruction data into a main arithmetic unit in case the characteristic of the instruction data corresponds to the normal instruction data in the result of the above determination; and
calculating in the main arithmetic unit, according to the decoded instruction data by reading a data necessary for calculating from the on-chip data memory.

7. The method of claim 5, further comprising the steps of:
transmitting the decoded instruction data into a main arithmetic unit and sub arithmetic unit in case the characteristic of the instruction data corresponds to the SIMD instruction data in the result of the above determination; and
calculating in the main arithmetic unit and sub arithmetic unit respectively, according to the decoded instruction data by reading a data necessary for calculating from the on-chip data memory.

8. The method of claim 7, wherein the calculations in the main arithmetic unit and sub arithmetic unit are identical.

9. The method of claim 5, further comprising the steps of:
calculating according to the decoded instruction data in case the characteristic of the instruction data corresponds to a predetermined conditional branch in the result of the above determination; and
respectively decoding the instruction data by fetching simultaneously the instruction data which will be performed in case the condition of the conditional branch is satisfied and in case not satisfied and calculating according to the decoded instruction data.

10. The method of claim 9, wherein the step of calculating comprises:
decoding the instruction data by fetching the instruction data which will be performed in case the condition of the conditional branch is satisfied and decoding in the sub instruction decoder by fetching the instruction data which will be performed in case the condition of the conditional branch, at the same time; and
calculating the in the main arithmetic unit and sub arithmetic unit respectively, according to the decoded instruction data by reading a data necessary for calculating from the on-chip data memory.

11. The method of claim 10, further comprising a step of:
maintaining the state information of the main instruction decoder and main arithmetic unit if the condition that the condition is satisfied, after determining the condition of the conditional branch, and deleting the state information of the sub instruction decoder and sub arithmetic unit.

12. The method of claim 10, further comprising a step of:
deleting the state information of the main instruction decoder and main arithmetic unit if the condition that the condition is not satisfied, after determining the condition of the conditional branch, and replacing the information with the state information of the sub instruction decoder and sub arithmetic unit.

13. An arithmetic method for a Single Instruction Multiple Data (SIMD) digital signal processor, comprising the steps of:
determining the characteristic of the decoded instruction data by decoding the instruction data fetched from the on-chip program memory in the main instruction decoder;
transmitting the decoded instruction data into the main arithmetic unit in case the characteristic of the instruction data corresponds to a predetermined conditional branch in the result of the above determination;
calculating the condition of the conditional branch in the main arithmetic unit according to the decoded instruction data by reading the data necessary for calculating from an on-chip data memory;
decoding the instruction data respectively in the main instruction decoder and sub instruction decoder by simultaneously fetching the instruction data which will be performed in case the condition of the conditional branch is satisfied and in case not satisfied and then calculating respectively in the main arithmetic unit and sub arithmetic unit according to the decoded instruction data; and
deleting one among the state information of the main instruction decoder and main arithmetic unit and the state information of the sub instruction decoder and sub arithmetic unit, according to the satisfaction of the condition, when the condition of the conditional branch is determined.

14. The method of claim 13, further comprising the steps of:
transmitting the decoded instruction data into the main arithmetic unit in case the characteristic of the instruction data corresponds to a normal instruction data in the result of the above determination
calculating the condition of the conditional branch in the main arithmetic unit, according to the decoded instruction data by reading the data necessary for calculating from the on-chip data memory.

15. The method of claim 13, further comprising the steps of:
transmitting the decoded instruction data into a main arithmetic unit and sub arithmetic unit in case the characteristic of the instruction data corresponds to the SIMD instruction data in the result of the above determination; and
calculating in the main arithmetic unit and sub arithmetic unit respectively, according to the decoded instruction data by reading a data necessary for calculating from the on-chip data memory.

16. The method of claim 13, wherein the condition is satisfied, the state information of the main instruction decoder-and main arithmetic unit is left as it is and the state information of the sub instruction decoder and sub arithmetic unit is deleted.

17. The method of claim 13, wherein the condition is not satisfied, the state information of the state information of the main instruction decoder and main arithmetic unit is deleted and the information is replaced by the state information of the sub instruction decoder and sub arithmetic unit.
